(19) United States
(12) Patent Application Publication
(10) Pub. No.: US 2011/0181794 A1
(43) Pub. Date: Jul. 28, 2011

(54) VIDEO DISPLAY APPARATUS AND VIDEO DISPLAY METHOD

(75) Inventor: Daisuke KOBAYASHI, Tokyo (JP)

(73) Assignee: Kabushiki Kaisha Toshiba, Tokyo (JP)

(21) Appl. No.: 12/900,442

(22) Filed: Oct. 7, 2010

(30) Foreign Application Priority Data
Jan. 28, 2010 (JP) 2010-016233

(51) Int. Cl. G09G 3/36

(52) U.S. Cl. 348/790

(57) ABSTRACT

According to one embodiment, a video display apparatus includes: a backlight; a motion detector configured to detect motion between frames or fields of an input video signal; a transmission-type display panel configured to control transmission of light coming from the backlight according to the input video signal; and a lighting time controller configured to control a lighting time of the backlight based on a detection result of the motion detector.

### CROSS-REFERENCE TO RELATED APPLICATION

This application is based on and claims priority under 35 U.S.C. §119 from Japanese Patent Application No. 2010-016233 filed on Jan. 28, 2010, the entire contents of which are incorporated herein by reference.

### FIELD

Embodiments described herein relate generally to a video display apparatus and, more particularly, to a backlight control method.

### BACKGROUND

Cold cathode fluorescent lamps and light-emitting diodes (hereinafter referred to as LEDs) are used as backlights of liquid crystal display devices etc. Previously, liquid crystal display devices are configured in such a manner that the luminance of the backlight is always kept constant over time in a display state. However, in recent years, with the rapid trend of employment of LEDs as backlights, the backlight dimming control has become easier and a control has become possible in which the luminance is varied at so high a speed as to be synchronized with an image.

In the above circumstances, to further increase the contrast utilizing the backlight luminance control, a drive method has been proposed in which while the backlight luminance is varied according to an image, the gradation is switched so that the display γ characteristic is kept ideal even if the luminance is switched.

Recently, as proposed in JP-A-2009-175415, a technique has been developed in which a backlight is divided into plural illumination areas and the luminance is controlled according to an input image signal on an area-by-area basis. Since the luminance of each illumination area is controlled according to an image signal, this method makes it possible to increase the luminance for a display portion including a number of pieces of bright image information and, conversely, lower the luminance for a display portion including a number of pieces of dark image information. The dynamic range of the entire image can thus be increased further.

In particular, in the technique described in JP-A-2009-175415, in a liquid crystal display device, a backlight control section increases the area of each illumination area as the motion vector of an object in an image calculated based on an image signal moves faster.

However, no technique has been disclosed which varies the illumination time of each illumination area according to the motion vector detection result of video. In particular, in the case of video with relatively less motion, it is desired to lower the degree of backlight afterglow which would feel incongruous at a switching point where an input video signal makes a transition from a moving image to a still image.

### BRIEF DESCRIPTION OF THE DRAWINGS

A general architecture that implements the various features of the invention will now be described with reference to the drawings. The drawings and the associated descriptions are provided to illustrate embodiments of the invention and not limited the scope of the invention.

FIG. 1 is an explanatory block diagram showing the configuration of a liquid crystal display apparatus according to an embodiment of the present invention.

FIG. 2 is an explanatory block diagram showing a functional configuration of the liquid crystal display apparatus according to the embodiment.

FIG. 3 is an explanatory block diagram showing the details of a video signal processor in the functional configuration of FIG. 2.

FIG. 4 is an explanatory block diagram showing the details of a backlight control signal processor in the functional configuration of FIG. 2.

FIGS. 5A and 5B illustrate an IIC interface used in the embodiment.

### DETAILED DESCRIPTION

Various embodiments according to the invention will be described hereinafter with reference to the accompanying drawings.

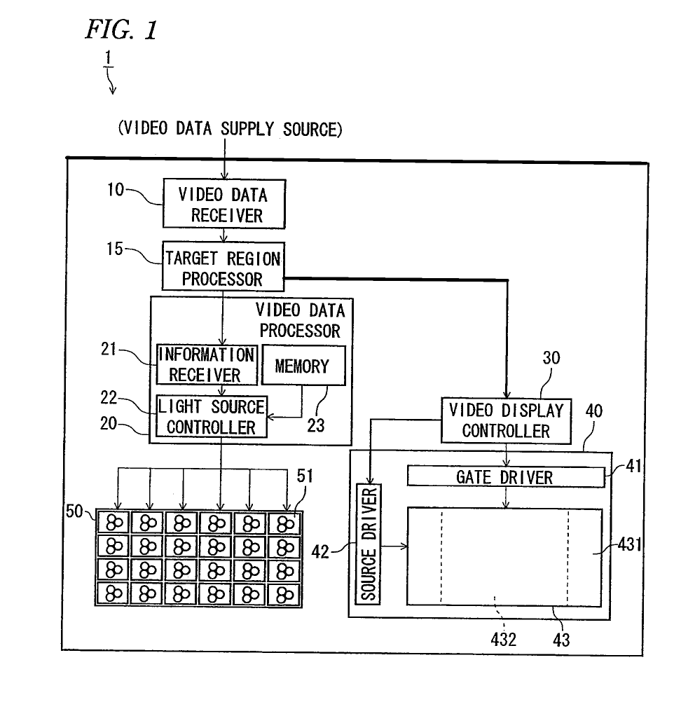

An embodiment of the present invention will be hereinafter described with reference to FIGS. 1 to 5B.

FIG. 1 is an explanatory block diagram showing the configuration of a liquid crystal display apparatus 1 according to the embodiment of the invention. As shown in FIG. 1, the liquid crystal display apparatus 1 is equipped with a video data receiver 10, a target region processor 15, a video data processor 20, a video display controller 30, a display module 40, and a backlight 50 as a light source.

Connected to an outdoor antenna (not shown), for example, the video data receiver 10 receives video data via the antenna. The video data receiver 10 can receive various kinds of video data that are carried by ground-wave analog waves, ground-wave digital waves, satellite broadcast waves, etc. The video data receiver 10 can also be connected to any of various video reproducing apparatus (e.g., HD DVD player, HD DVD recorder, DVD player, and DVD recorder; not shown). When connected to such a video reproducing apparatus, the video data receiver 10 receives video data that is reproduced by the video reproducing apparatus.

The video data receiver 10 outputs the received video data to the video data processor 20 and the video display controller 30 via the target region processor 15. Video data that is received by the video data receiver 10 has one of various specific aspect ratios such as 4:3 and 16:9. The aspect ratio is the ratio of the horizontal width to the vertical width of video data.

Video data has video aspect ratio information indicating its aspect ratio.

The video display controller 30 receives the video data from the video data receiver 10 and causes the display module 40 to display video.

The display module 40 is mainly constituted by a liquid crystal panel 43, a gate driver 41, and a source driver 42.

The liquid crystal panel 43 has an aspect ratio 16:9. For example, video data having an aspect ratio 16:9 is displayed in a display area 431 having an aspect ratio 16:9, that is, the entire display area, of the liquid crystal panel 43. Video data having an aspect ratio 4:3 is displayed in a central display area 432 (indicated by broken lines) having an aspect ratio 4:3.

Although not shown in any drawing, the liquid crystal panel 43 is configured in such a manner that a liquid crystal is sandwiched between two glass plates and scanning lines and data lines are arranged in lattice form on the glass plates. The scanning lines and the data lines are controlled being driven by the gate driver 41 and the source driver 42, respectively, which are provided along end lines of the liquid crystal panel 43. The gate driver 41 has a function of outputting pulse voltages to the scanning lines sequentially.

The source driver 42 supplies voltages to the liquid crystal as the gate driver 41 outputs the pulse voltages. The liquid crystal 43 displays video as such voltages are applied to the liquid crystal through the driving by the gate driver 41 and the source driver 42.

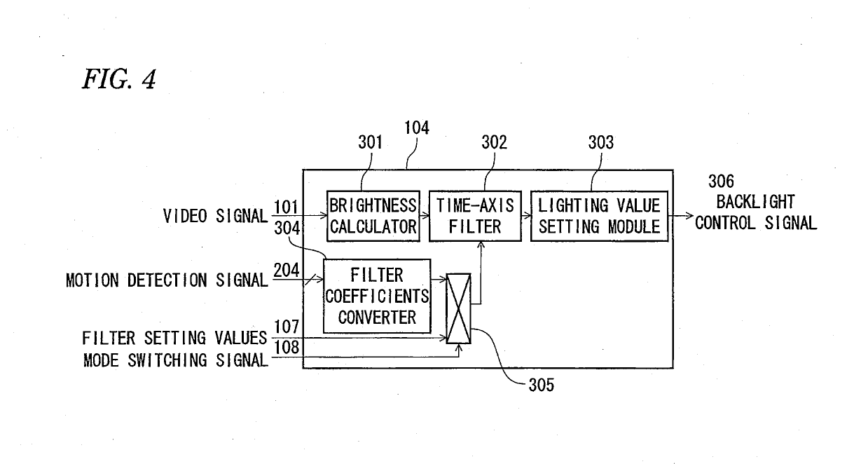

The video data processor 20 is constituted by an information receiver 21, alight source controller 22, and a memory 23. For pieces of processing shown in FIG. 4 (described later), the target region processor 15 is equipped with, for example, a CPU, a ROM for storing programs, a RAM to serve as a work area, etc. (none of which are shown). The information receiver 21 receives the video data that is output from the video data receiver 10. The information receiver 21 acquires the video aspect ratio information that is contained in the received video data, and outputs the acquired video aspect ratio information to the light source controller 22.

The memory 23 is stored with backlight turn-on/off table data to be referred to by the light source controller 22 in controlling light source modules 51. The backlight turn-on/off table data is information to be used for turning on/off the light source modules 51 which constitute a backlight 50. Different sets of backlight turn-on/off table data are provided for respective aspect ratios of video data.

The light source controller 22 reads backlight turn-on/off table data from the memory 23. The light source controller 22 controls the turn-on/off of the light source modules 51 which constitute the backlight 50 based on backlight turn-on/off table data corresponding to the video aspect ratio information that is output from the information receiver 21. As such, the light source controller 22 functions as a lighting controller.

The backlight 50 (i.e., light source modules 51) supplies light to the display area 431 or 432 of the display module 40. As such, the backlight 50 functions as a light source.

The backlight 50 is provided on the back side of the liquid crystal panel 43. Although not shown in any drawing, a pair of diffusion plates and a prism sheet (sandwiched between the pair of diffusion plates) are disposed between the backlight 50 and the liquid crystal panel 43. The pair of diffusion plates serve to scatter and diffuse light that is supplied from the light source modules 51 and thereby cause the entire display area to have uniform brightness.

The prism sheet is to increase the luminance of light that is supplied from the backlight 50.

Each light source module 51 is constituted by plural LEDS (light emitting diodes) that emit light beams of the three primary colors, that is, red (hereinafter abbreviated as R), green (hereinafter abbreviated as G), and blue (hereinafter abbreviated as B). Each light source module 51 can emit white light by mixing light beams that are emitted from the R, G, and B LEDs.

In the invention, no limitations are imposed on how each light source module 51 is configured by LEDs. For example, each light source module 51 may be a set of one R LED, two G LEDs, and one B LED or a set of two R LEDs, three G LEDs, and one B LED.

The number of colors of LEDs constituting each light source module 51 is not limited to three; each light source module 51 may be formed by any of various combinations of LEDs such as LEDs of four or more colors or a white LED.

Furthermore, the light source element that is used for forming each light source module 51 is not limited to the LED and may be any of various kinds of light-emitting elements. Example light-emitting elements are the organic EL (electroluminescence) device, inorganic EL device, and laser diode (LD).

As for the division number of the backlight 50, 8×8 division and 8×16 division, for example, are in practical use now. With this arrangement, a control can be performed for each region extending in the line direction. Naturally, the backlight 50 can also be controlled like an area control.

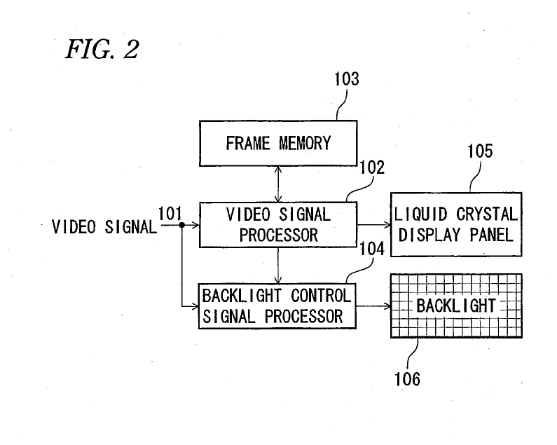

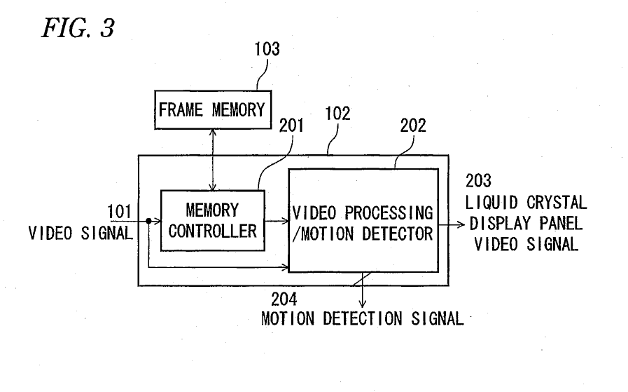

FIG. 2 shows an explanatory functional configuration of the liquid crystal display apparatus 1. FIG. 3 is an explanatory block diagram showing the internal configuration of a video signal processor 102 shown in FIG. 2. FIG. 4 is an explanatory block diagram showing the internal configuration of a backlight control signal processor 104 shown in FIG. 2.

First, the functional configuration of the liquid crystal display apparatus 1 will be described with reference to FIG. 2. As shown in FIG. 2, the liquid crystal display apparatus 1 is constituted by the video signal processor 102, a frame memory 103, the backlight control signal processor 104, a liquid crystal display panel 105, and a backlight 106 (corresponding to the backlight 50 shown in FIG. 1).

The video signal processor 102 performs detection of motion between frames of an input video signal 101 and processing (frame rate doubling conversion etc.) that is suitable for the specification of the liquid crystal display panel 105, and outputs a resulting video signal to the liquid crystal display panel 105. The backlight control signal processor 104 calculates backlight lighting values based on the input video signal 101 and a motion detection signal, and outputs a backlight control signal to the backlight 106 which is divided into plural areas.

Next, the video signal processor 102 will be described with reference to FIG. 3. An input video signal 101 is input to a memory controller 201 and a video processing/motion detector 202. The memory controller 201 delays the input video signal 101 by one frame and outputs a resulting video signal to the video processing/motion detector 202 while controlling the frame memory 103. The video processing/motion detector 202 generates a motion detection signal 204 of, for example, 3 bits (“0” (minimum motion) to “7” (maximum motion)) based on differences between the one-frame-delayed video signal and the current video signal. The video processing/motion detector 202 generates interpolation frames between the one-frame-delayed video signal and the current video signal according to the specification of the liquid crystal display panel 105, performs frame rate doubling processing on a resulting signal, and outputs a resulting liquid crystal display panel video signal 203.

Next, the backlight control signal processor 104 will be described with reference to FIG. 4. An input video signal 101 is input to a brightness calculator 301, which calculates brightness values (e.g., numbers from 0 to 255) for the respective divisional areas of the backlight 106. A time-axis filter 302 controls the brightness in the time-axis direction. Alighting value setting module 303 converts a resulting signal into a backlight control signal 306 that is suitable for the control method of the backlight 106, and outputs it.

Furthermore, a filter coefficients converter 304 performs conversion into filter coefficients suitable for the motion of the video signal 101 according to the motion detection signal 204, and controls the lighting time length characteristic of the time-axis filter 302 using those filter coefficients. This characteristic control sets the lighting time in such a manner that, for example, the lighting time is set to a one-frame interval, a two-frame interval, and a three-frame interval when the motion detection signal 204 is “0” to “2,” “3” to “5,” and “6” to “7,” respectively. A control using filter setting values 107 can also be performed as in the conventional case by using a mode switching signal 108 which is input to a filter coefficients switching selector 405 from an IIC bus. The mode switching signal 108 may have, for example, a default value that is set in advance by a microcomputer (not shown) of the TV (video signal supply source).

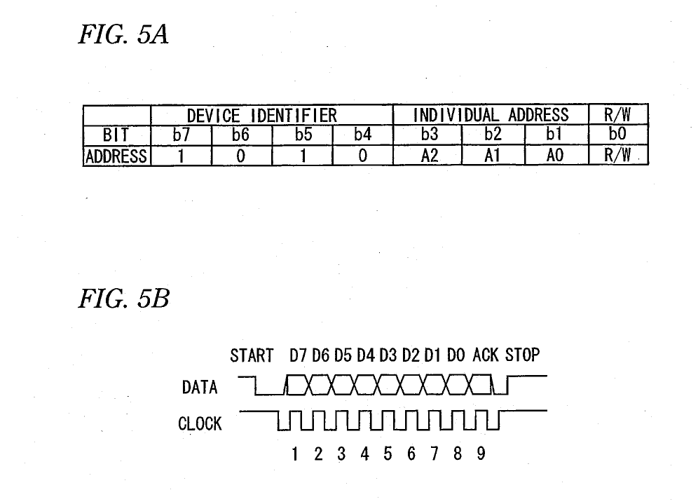

FIGS. 5A and 5B illustrate an IIC interface. The bus (IIC bus) of the IIC interface includes two communication lines, that is, a clock line for a pulled-up clock that is output from a master device and a data line for data to be used for bidirectional communication between the master device and a slave device.

FIG. 5A shows an example structure of a slave address. The slave address has an 8-bit length and the values of the upper 4 bits are fixed according the kind of a device. The LSB represents writing and reading when it has values “0” and “1,” respectively. Therefore, in practice, only bit 1 to bit 3 of the slave address are usable.

FIG. 5B schematically shows timing between the two lines. As shown in the top part of FIG. 5B, transmission is started when the signal level of the data line goes low. Data are transmitted starting from the MSB. The transmission is stopped when the signal level of the data line goes high. The bottom part of FIG. 5B shows a clock on the clock line. Whereas FIG. 5B shows an example of 1-byte transmission, transmission of a set of data and an acknowledgment may be repeated plural times until establishment of s stop state, whereby a slave address is transmitted as a first byte and substance is transmitted as following bytes.

Video display apparatus having the following features have been described in the embodiment:

(1) A video display apparatus including:

a backlight, divided into plural areas, of a video display panel;

a calculator configured to calculate brightness values for the respective divisional areas based on an input video signal;

a backlight lighting value calculation filter;

a setting module configured to set lighting values of the backlight for the respective divisional areas;

a holder configured to hold the input video signal in units of a frame; and

a motion detector configured to detect motion between frames of the input video signal, wherein

the characteristic of the backlight lighting value calculation filter can be varied according to a detection result of the motion detector.

(2) The video display apparatus of item (1), wherein

the characteristic (bandwidth) of the backlight lighting value calculation filter is set narrower when the motion detection value is smaller, and

the characteristic (bandwidth) of the backlight lighting value calculation filter is set broader when the motion detection value is larger.

The embodiment provides an advantage that since a result of motion detection on an input video signal is added to items based on which to determine the manner of lighting of the backlight (particularly in the manner described in item (2)), the degree of backlight afterglow which would feel incongruous at a switching point where an input video signal makes a transition from a moving image to a still image can be lowered.

Namely, the embodiment provides a video display apparatus and a video display method which can lower the degree of backlight afterglow according to a motion variation of a moving image.

Although the embodiments according to the present invention have been described above, the present invention is not limited to the above-mentioned embodiments but can be variously modified. Components disclosed in the aforementioned embodiments may be combined suitably to form various modifications. For example, some of all components disclosed in the embodiments may be removed or may be appropriately combined.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A video display apparatus comprising:
a backlight;
a motion detector configured to detect motion between frames or fields of an input video signal;
a transmission-type display panel configured to control transmission of light coming from the backlight according to the input video signal; and
a lighting time controller configured to control a lighting time of the backlight based on a detection result of the motion detector.

2. The apparatus of claim 1,
wherein the lighting time of the backlight is set shorter when a motion detection value of the detection result of the motion detector is smaller, and
wherein the lighting time of the backlight is set longer when a motion detection value of the detection result of the motion detector is larger.

3. A video display method of a video display apparatus configured to control a backlight and a transmission-type display panel capable of controlling transmission of light through thereof, the method comprising:
detecting motion between frames or fields of an input video signal;
controlling a lighting time of the backlight based on the detected motion; and
displaying video based on a result of the control of the lighting time.

4. The method of claim 3,
wherein the lighting time of the backlight is set shorter when a motion detection value of the detected motion is smaller, and
wherein the lighting time of the backlight is set longer when a motion detection value of the detected motion is larger.
